(19) United States
(12) Patent Application Publication
(10) Pub. No.: US 2021/0156385 A1
(43) Pub. Date: May 27, 2021

(54) INTELLIGENT WATER PUMP WITH LOW WATER LEVEL

(71) Applicant: Shenzhen Liyijiujiu Network Technology Co. Ltd., Shenzhen (CN)

(72) Inventor: Xuzhong WANG, Dongguan (CN)

(73) Assignee: Shenzhen Liyijiujiu Network Technology Co. Ltd., Shenzhen (CN)

(21) Appl. No.: 16/739,156

(22) Filed: Jan. 10, 2020

(30) Foreign Application Priority Data
Nov. 22, 2019 (CN) 201922038558.X

(51) Int. Cl. F04D 15/02; F04D 13/08; A01K 7/02

(52) U.S. Cl. CPC F04D 15/0218; A01K 7/02; F04D 13/086

(57) ABSTRACT

The present invention discloses an intelligent low-water-level pump, which comprises an upper cover, a lampshade, an LED lamp, a circuit board, a power supply coil, a probe, a water outlet, a pump main body, a rotor, a sealing cover and a bottom cover. The pump main body is provided with the upper cover and the bottom cover and also has an accommodating space, and the power supply coil is arranged in the accommodating space. The rotor is arranged at the lower end of the power supply coil, and the sealing cover is arranged at the lower end of the rotor.

### TECHNICAL FIELD

The present invention relates to an intelligent low-water-level pump, and in particular to an intelligent low-water-level pump for a pet waterer.

### BACKGROUND

The existing pet waterer has two types of special water pumps, namely a common water pump and an intelligent water pump.

The two types of water pumps are powered by coils, wherein the coil supplies power to form an electromagnetic field to drive a rotor to rotate so as to achieve a water pumping effect. The intelligent water pump additionally has an intelligent water level detection function, so it can automatically stop operating when the water level is lower than a probe to prevent damage caused by idling. In the two types of water pumps, the rotor is transversely arranged, the power supply coil is vertically arranged, and a water inlet is arranged on a side face. Such structure is easy to be implemented, and the testing procedure is simple, so a water pump having such structure become a standard water pump for most of pet waterers on the market.

The common water pump only has a water pumping function and cannot automatically power off, so, when the water level is lower than the water inlet, the water pump still operates, and a user cannot know that the water pump is idling, thereby causing damage to the water pump and shortening the service life of the water pump.

Because the rotor is transversely arranged, the water inlet only can be arranged on the side face of the water pump and is much higher than the bottom of the pet waterer. The water pump cannot pump out water when the water level is lower than the water inlet, so there is water to be left, and the left water cannot be utilized. Therefore, the water pump has low utilization rate of the water. Furthermore, based on measurement, the lowest water level of the existing water pump mostly is 15 mm (away from the bottom of the pet waterer).

### SUMMARY

A first technical problem to be solved by the present invention is to change structures of a rotor and a power supply coil, wherein the rotor is vertically arranged in a pump main body, and a water inlet is arranged at the bottom of the pump main body, so the distance between the water inlet and the bottom of a pet waterer is greatly shortened, and the utilization rate of water is maximized.

A second technical problem to be solved by the present invention is to add a probe and an LED lamp to the a water pump, wherein, when the water level is level with the water inlet, the water pump automatically powers off, and the LED lamp flashes to remind a user to add water so as to protect the water pump; when the added water submerges the probe, the water pump automatically restarts operating, and the LED lamp is off.

To solve the above-mentioned technical problems, the present invention adopts the following technical solution:

An intelligent low-water-level pump comprises an upper cover (1), a lampshade (2), an LED lamp (3), a circuit board (4), a power supply coil (5), a probe (6), a water outlet (7), a pump main body (8), a rotor (9), a sealing cover (10) and a bottom cover (11). The pump main body (8) is provided with the upper cover (1) and the bottom cover (11) and also has an accommodating space, and the power supply coil (5) is arranged in the accommodating space. The rotor (9) is arranged at the lower end of the power supply coil (5), and the sealing cover (10) is arranged at the lower end of the rotor. The water outlet (7) is arranged at a side of the pump main body (8). The power supply coil (5), the circuit board (4) and the probe (6) are sealed in the pump main body (8) by the matching of the pump main body (8) and the upper cover (1). The rotor (9) is vertically placed in the pump main body (8), and the whole water inlet (7) is arranged on the bottom cover (11).

Preferably, the rotor (9) is inserted into a hole of the pump main body (8), and the power supply coil (5) is powered on such that the rotor (9) rotates to achieve a water pumping effect. When the water level is lower than the probe (6), the power supply coil (5) is powered off such that the rotor (9) stops rotating, then the pump stops operating, and simultaneously, the LED lamp (3) flashes to remind a user to add water.

Preferably, foot pads (12) are arranged on the lower surface of the bottom cover (11).

The intelligent low-water-level pump of the present invention can maximize the utilization rate of water, automatically powers off, automatically restarts operating, and reminds the user to add the water through the LED lamp, so product experience is better.

Other features and advantages of the present invention will be described in the following specification, and some of these will become apparent from the description or be understood by implementing the present invention. The objectives and other advantages of the present invention can be implemented or obtained by structures specifically indicated in the written specification, claims, and accompanying drawings.

### BRIEF DESCRIPTION OF THE DRAWINGS

To make the foregoing advantages of the present invention clearer, the present invention is described in detail below with reference to the accompanying drawings.

FIG. 1 is an exploded view of an intelligent low-water-level pump of the present invention.

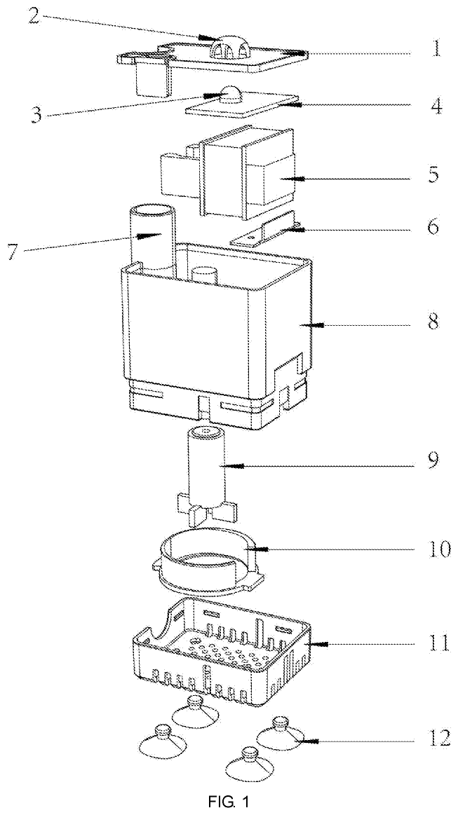

FIG. 2 is a sectional view of the intelligent low-water-level pump of the present invention.

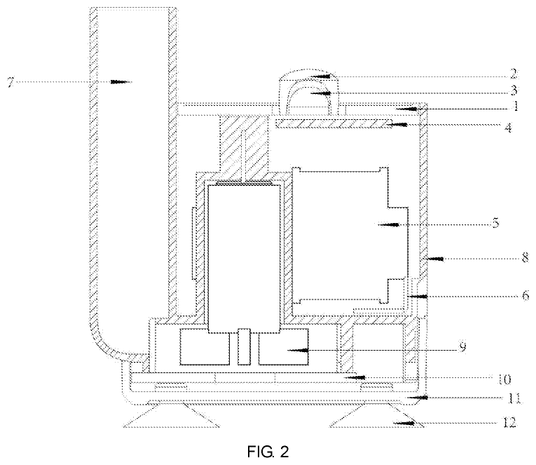

FIG. 3 is a schematic structural diagram of the intelligent low-water-level pump of the present invention.

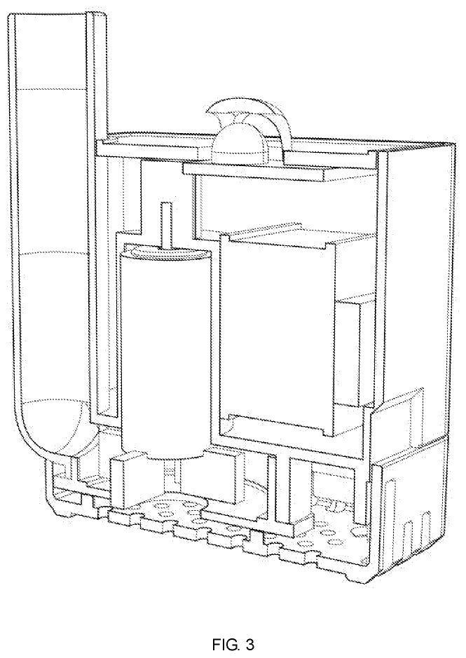

FIG. 4 is a schematic structural diagram of the intelligent low-water-level pump of the present invention.

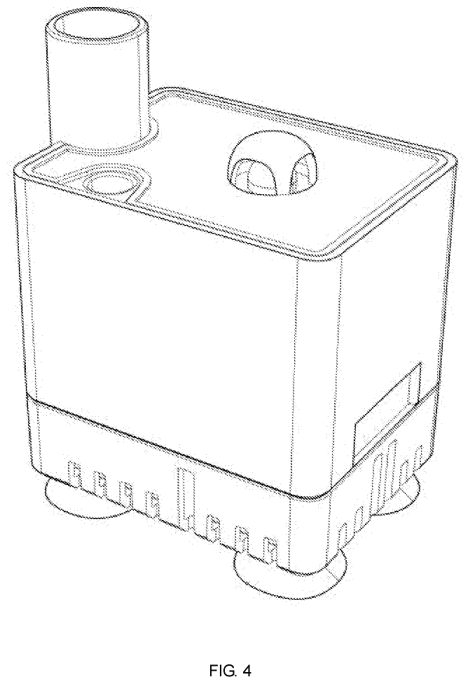

### DESCRIPTION OF THE EMBODIMENTS

The following describes the present invention in detail with reference to the specific embodiments.

Specifically, the present invention provides an intelligent low-water-level pump. The intelligent low-water-level pump mainly comprises an upper cover (1), a lampshade (2), an LED lamp (3), a circuit board (4), a power supply coil (5), a probe (6), a water outlet (7), a pump main body (8), a rotor (9), a sealing cover (10), a bottom cover (11) and foot pads (12).

The pump main body (8) is fabricated by plastic. The power supply coil (5), the circuit board (4) and the probe (6) are sealed in the pump main body (8) by the matching of the pump main body (8) and the upper cover (1) so as to achieve a waterproof effect. The rotor (9) is inserted into a hole of the pump main body (8), and the power supply coil (5) is powered on such that the rotor (9) rotates to achieve a water pumping effect. When the water level is lower than the probe (6), the power supply coil (5) is powered off such that the rotor (9) stops rotating, then the pump stops operating, and simultaneously, the LED lamp (3) flashes to remind a user to add water.

The rotor (9) is vertically arranged so that the water inlet can be completely arranged on the bottom cover (11) to achieve the lowest water level.

The intelligent low-water-level pump of the present invention is applied to products such as pet waterers, its water level is low, consumed energy is less, and mounting is simple. Furthermore, an intelligent power off function and a reminding function bring better product experience for the user.

Finally, it should be noted that the foregoing embodiment is merely a preferred embodiment of the present invention, but not for limiting the present invention. Although the present invention is described in detail with reference to the foregoing embodiment, persons skilled in the art may still make modifications to the technical solution described in the foregoing embodiment or make equivalent substitutions to some technical features thereof. Any modifications, equivalent substitutions, improvements, and the like within the spirit and principles of the present invention are intended to be included within the protection scope of the present invention.

What is claimed is:

1. An intelligent low-water-level pump, comprising an upper cover, a lampshade, an LED lamp, a circuit board, a power supply coil, a probe, a water outlet, a pump main body, a rotor, a sealing cover and a bottom cover, wherein the pump main body is provided with the upper cover and the bottom cover, the pump main body has an accommodating space, the power supply coil is arranged in the accommodating space, the rotor is arranged at the lower end of the power supply coil, and the sealing cover is arranged at the lower end of the rotor; the water outlet is arranged at a side of the pump main body; the pump main body is coupled with the upper cover such that the power supply coil, the circuit board and the probe are sealed in the pump main body; the rotor is vertically placed in the pump main body, and the whole water inlet is arranged on the bottom cover.

2. The intelligent low-water-level pump according to claim 1, wherein the rotor is inserted into a hole of the pump main body, and the power supply coil is powered on such that the rotor rotates to achieve a water pumping effect; when the water level is lower than the probe, the power supply coil is powered off such that the rotor stops rotating, then the pump stops operating, and simultaneously, the LED lamp flashes to remind a user to add water.

3. The intelligent low-water-level pump according to claim 1, wherein foot pads are arranged on the lower surface of the bottom cover.

4. The intelligent low-water-level pump according to claim 2, wherein foot pads are arranged on the lower surface of the bottom cover.
